(19) United States
(12) Patent Application Publication
(10) Pub. No.: US 2021/0114625 A1
(43) Pub. Date: Apr. 22, 2021

(54) SYSTEM AND METHOD FOR AUTONOMOUS COLLISION AVOIDANCE

(71) Applicant: WeRide Corp., San Jose, CA (US)

(72) Inventor: Zhilong LIU, San Jose, CA (US)

(21) Appl. No.: 17/072,057

(22) Filed: Oct. 16, 2020

Related U.S. Application Data
(60) Provisional application No. 62/916,807, filed on Oct. 18, 2019.

(51) Int. Cl. B60W 60/00; B60W 30/095; B60W 30/09

(52) U.S. Cl. CPC B60W 60/0018; B60W 30/0953; B60W 2554/4044; B60W 2520/06; B60W 2554/20; B60W 30/09

(57) ABSTRACT

A collision avoidance method for an autonomous driving vehicle (ADV), the method comprising: A) obtaining a current vehicle state of the ADV and a planned trajectory of the ADV over a predetermined drive period, wherein the planned trajectory is generated according to an initial vehicle state of the ADV and an environment of the ADV when the ADV is at the initial vehicle state, and wherein the initial vehicle state is a vehicle state of the ADV when the ADV is at a start point of the predetermined drive period; B) generating a simulated trajectory over at least a portion of the predetermined drive period based on the current vehicle state and the planned trajectory; C) determining whether the simulated trajectory overlaps with an obstacle; and D) decelerating the ADV in response to a determination result that the simulated trajectory overlaps with an obstacle.

### TECHNICAL FIELD

The application generally relates to autonomous driving technologies, and in particular, to collision avoidance of an autonomous driving vehicle.

### BACKGROUND

Autonomous driving is a challenging task that integrates many technologies.

An autonomous driving system generally has several components that enable autonomous driving without human participation, including a localization module to determine where the vehicle is, a perception module to determine the surrounding environment of the vehicle and a control module to determine how to drive based on the available information. Typically, an autonomous vehicle generates a planned trajectory based on the output from the localization module and the perception module. The control module then outputs the vehicle's throttle, brake and steering in order to follow the planned trajectory.

Compared with conventional driving on streets and highways, in some low-speed driving scenarios which may need very large road wheel angles (for example, driving in a parking lot), collision avoidance is extremely difficult. Even though the planned trajectory generated based on the initial vehicle state and surrounding environment of the autonomous driving vehicle is collision-free, the vehicle may still collide with an obstacle due to large deviations between the actual trajectory and the planned trajectory. Therefore, there is a continued need for further improving a collision avoidance scheme.

### SUMMARY

In a first aspect, the present disclosure provides a collision avoidance method for an autonomous driving vehicle (ADV). In one embodiment, the method comprising: A) obtaining a current vehicle state of the ADV and a planned trajectory of the ADV over a predetermined drive period, wherein the planned trajectory is generated according to an initial vehicle state of the ADV and an environment of the ADV when the ADV is at the initial vehicle state, and wherein the initial vehicle state is a vehicle state of the ADV when the ADV is at a start point of the predetermined drive period; B) generating a simulated trajectory over at least a portion of the predetermined drive period based on the current vehicle state and the planned trajectory; C) determining whether the simulated trajectory overlaps with an obstacle; and D) decelerating the ADV in response to a determination result that the simulated trajectory overlaps with an obstacle.

In another aspect, the present disclosure provides a device for controlling an autonomous driving vehicle.

The foregoing has outlined, rather broadly, features of the present application. Additional features of the present application will be described, hereinafter, which form the subject of the claims of the present application. It should be appreciated by those skilled in the art that the conception and specific embodiments disclosed herein may be readily utilized as a basis for modifying or designing other structures or processes for carrying out the objectives of the present application. It should also be realized by those skilled in the art that such equivalent constructions do not depart from the spirit and scope of the present application as set forth in the appended claims.

### BRIEF DESCRIPTION OF THE DRAWINGS

The aforementioned features and other features of the present application will be further described in the following paragraphs by referring to the accompanying drawings and the appended claims. It will be understood that, these accompanying drawings merely illustrate certain embodiments in accordance with the present application and should not be considered as limitation to the scope of the present application. Unless otherwise specified, the accompanying drawings need not be proportional, and similar reference characters generally denote similar elements.

FIG. 1 illustrates an exemplary autonomous driving system.

FIGS. 2A-2E illustrate a low-speed driving scenario according to one embodiment of the present disclosure.

FIG. 3 illustrates a flow chart of a process for collision avoidance according to one embodiment of the present disclosure

FIG. 4 illustrates a flow chart of a process for generating a simulated vehicle state corresponding to a time step Tₖ according to one embodiment of the present disclosure, wherein k is a natural number.

FIG. 5 illustrates a flow chart of a process after decelerating the ADV according to one embodiment of the present disclosure.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The present disclosure relates to methods and systems for autonomous collision avoidance. For the sake of brevity, conventional techniques and components related to the autonomous driving technology and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

Autonomous Driving System

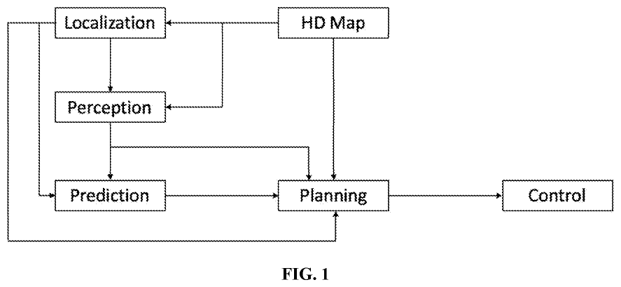

Autonomous driving vehicles (ADVs, also known as driverless cars, self-driving cars or robot cars) are capable of sensing its environment and navigating without human input. Autonomous driving system is a complex system integrating many technologies that coordinate to fulfill the challenging task of controlling a vehicle without human input. FIG. 1 illustrates an exemplary autonomous driving system that comprises functional subsystems, or modules, that work collaboratively to generate signals for controlling a vehicle.

Referring to FIG. 1, an autonomous driving system includes, or alternatively can access to, a map such as a high definition (HD) map that the ADV can use to plan its path. An HD map used by an ADV contains a huge amount of driving assistance information. The most important information is an accurate 2-dimensional or 3-dimensional representation of the road network, such as a layout of the roads and the intersections, and locations of signposts and other traffic control indications. The HD map also contains a lot of semantic information, such as what the color of traffic lights means, the speed limit of a lane and where a left turn begins. The major difference between the HD map and a traditional map is the precision—while a traditional map typically has a meter-level precision, the HD map requires a centimeter level precision in order to ensure the safety of an ADV. The HD map dataset may be stored in the ADV. Alternatively, the HD map dataset is stored and updated in a server (e.g., a cloud) that communicates with the ADV and provides the map information necessary for the ADV to use.

The information in the HD map is used by many other modules of the autonomous driving system. In the first place, a localization module depends on the HD map to determine the exact location of the ADV. The HD map also helps a perception module to sense the environment around the ADV when the surrounding area is out of the range of the sensors or blocked by an obstacle. The HD map also helps a planning module to find suitable driving space and to identify multiple driving routes. The HD map allows the planning module to accurately plan a path and choose the best maneuver.

A localization module of the autonomous driving system helps an ADV to know where exactly it is, which is a challenging task because any single sensor or instrument currently available, such as GPS and IMU, is insufficient to provide location information accurately enough for autonomous driving. Current localization technology uses information gathered by the sensors installed in the ADV to identify landmarks in the surrounding environment and determines the location of the ADV relative to the landmarks. The localization module then compares the landmarks identified by the sensors to the corresponding landmarks in the HD map, thereby determining the exact location of the ADV in the map. Typically, to ensure a localization of high precision required by autonomous driving, a localization module combines information collected by multiple sensors using different localization techniques, such as GNSS RTK (Global Navigation Satellite System Real-time Kinematics) used by GPS, inertial navigation used by IMU, LiDAR localization and visual localization.

A perception module of the autonomous driving system is configured to sense the surrounding of the ADV using sensors such as camera, radar and LiDAR and to identify the objects around the ADV. The sensor data generated by the sensors are interpreted by the perception module to perform different perception tasks, such as classification, detection, tracking and segmentation. Machine learning technologies, such as convolutional neural networks, have been used to interpret the sensor data. Technologies such as Kalman filter have been used to fuse the sensor data generated by different sensors for the purposes of accurate perception and interpretation.

Many of the objects around the ADV are also moving. Therefore, a prediction module of the autonomous driving system is configured to predict the behavior of these moving objects in order for the ADV to plan its path. Typically, the prediction module predicts the behavior of a moving object by generating a trajectory of the object. The collection of the trajectories of all the objects around the ADV forms a prediction of a timestep. For each timestep, the prediction module recalculates the prediction for every moving object around the ADV. These predictions inform the ADV to determine its path.

A planning module of the autonomous driving system incorporates the data from the HD map module, the localization module and the prediction module to generate a trajectory for the vehicle. The first step of planning is route navigation that generates a navigable path. Once a high-level route is built, the planning module zooms into trajectory planning, which makes subtle decisions to avoid obstacles and creates a smooth ride for the passengers, i.e., to generate a collision-free and comfortable trajectory to execute.

The trajectory generated in the planning module is then executed by a control module to generate a series of control inputs including steering, throttling and/or braking. Several conditions need be considered by the control module when generating control inputs. First, the controller needs to be accurate so that the result avoids deviation from the target trajectory, which is important for safety. Second, the control strategy should be feasible for the car. Third, comfortable driving is important for the passenger. Hence the actuation should be continuous and avoid sudden steering, acceleration or braking. In sum, the goal of the controlling module is to use viable control inputs to minimize deviation from the target trajectory and maximize passenger comfort.

Collision Avoidance Scheme

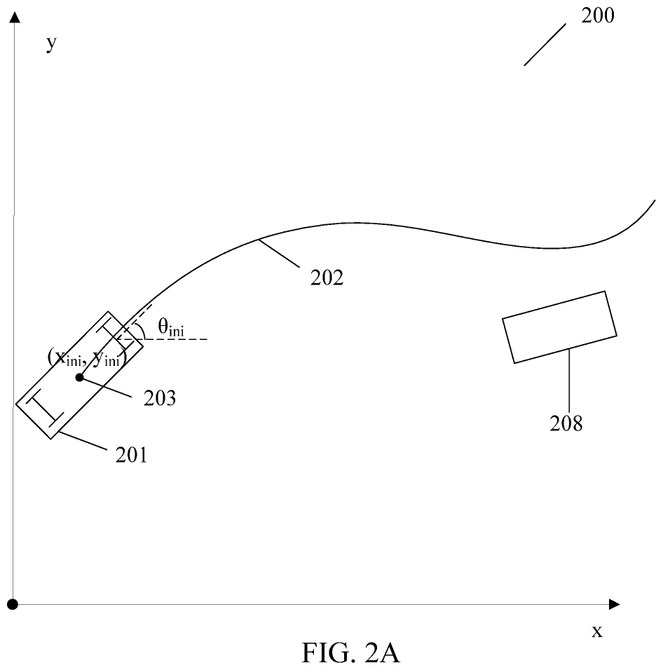

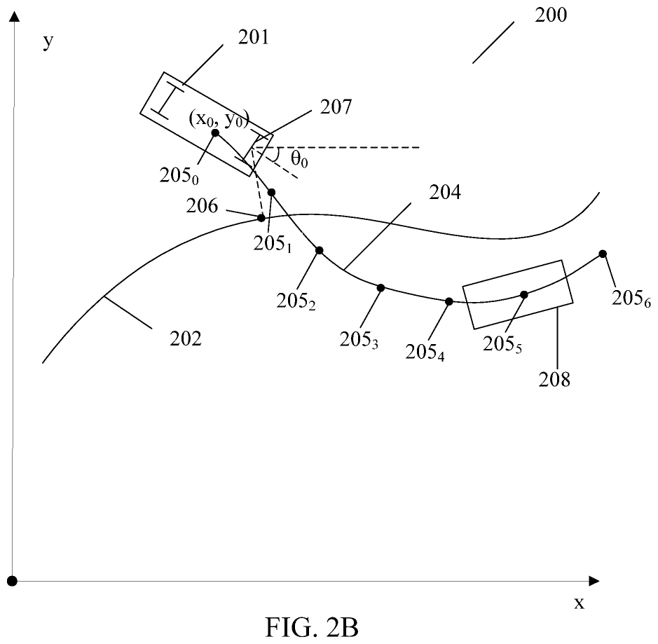

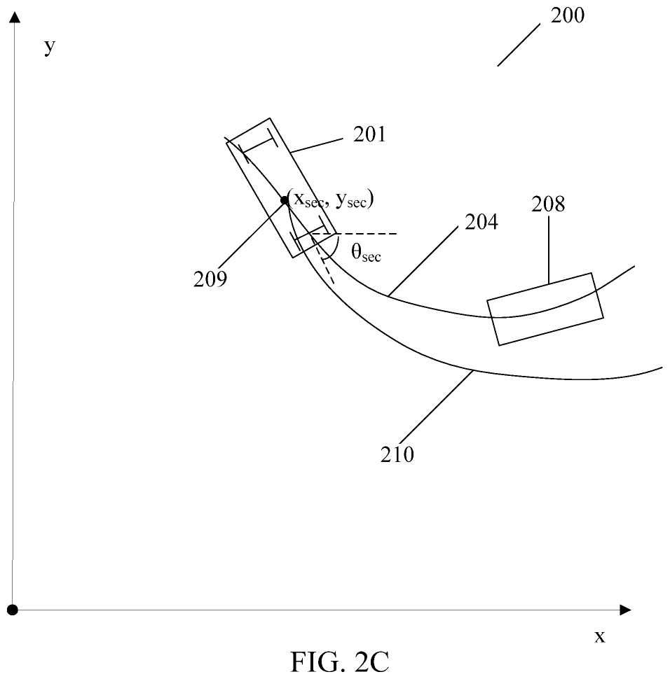

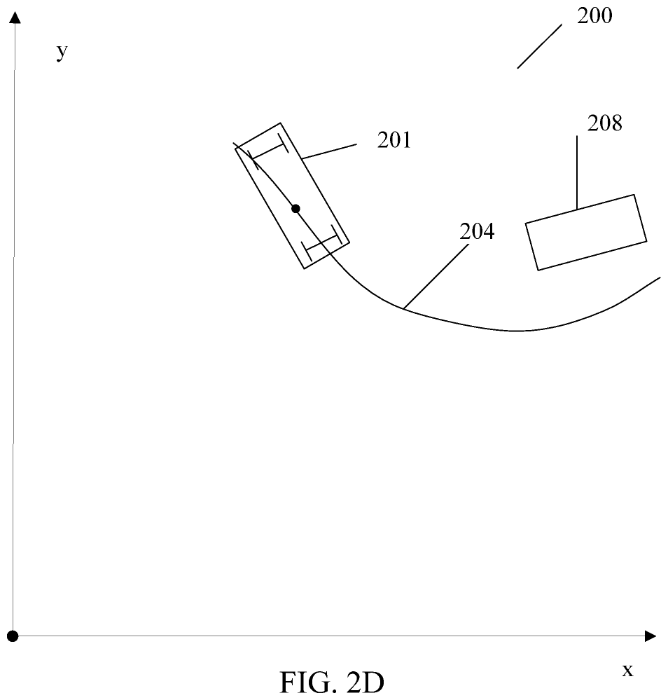

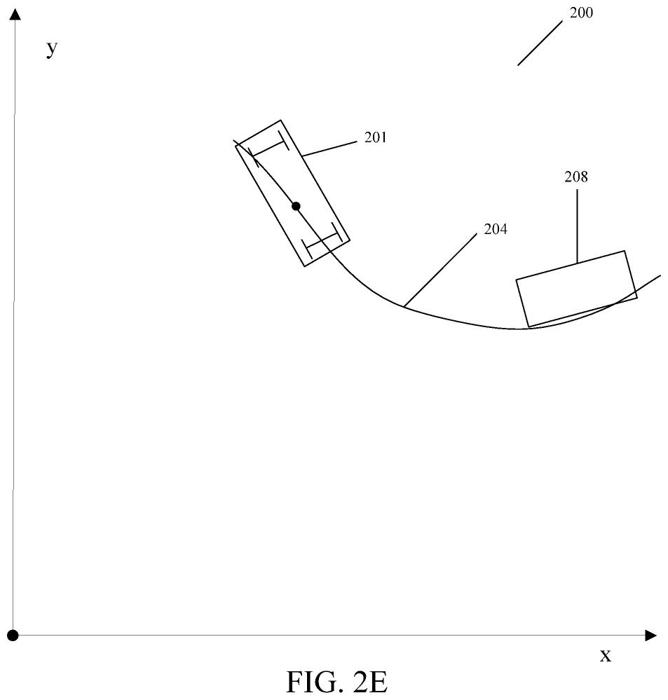

FIGS. 2A-2E illustrate a low-speed driving scenario 200 according to one embodiment of the present disclosure. As shown in FIG. 2A, an ADV 201 generates a planned trajectory 202 for a predetermined drive period based on an initial vehicle state of the ADV 201 and a surrounding environment of the ADV 201 when the ADV 201 is at the initial vehicle state. In this embodiment, the initial vehicle state refers to the vehicle state of the ADV 201 when the ADV 201 is at the start point 203 of the predetermined drive period. In some embodiments, the initial vehicle state may include an initial vehicle position (xᵢₙᵢ, yᵢₙᵢ) and an initial vehicle heading θᵢₙᵢ. The planned trajectory 202 is expected to be collision-free, i.e., does not overlap with any obstacles detected in the surrounding environment of the ADV 202 when the ADV 201 is at the initial vehicle state. It can be appreciated that the planned trajectory may be periodically generated, or may be generated in response to an event. For example, the event may be that the ADV 201 moves into a parking lot and decides to park at an unoccupied parking space.

Although the planned trajectory is expected to be collision-free, due to various reasons, the ADV 201 may deviate from the planned trajectory 202 during its movement. For example, imprecise execution of large road wheel angles may occur in the low-speed driving scenario 200. As times goes on, the deviation of the ADV 201 from the planned trajectory 202 may be significant, as shown in FIG. 2B, therefore the ADV 201 may collide with an obstacle in the surrounding environment. The collision avoidance scheme provided herein can prevent the ADV 201 from colliding with any obstacles, either stationary obstacles previously within the environment or dynamic obstacles such as a human being walking into the environment, by generating a simulated trajectory 204 for the ADV 201 over at least a portion of the predetermined drive period after a current vehicle state of the ADV 201. If it is determined that an obstacle 208 overlaps with the simulated trajectory 204, the ADV 201 may take different actions to avoid colliding with the obstacle 208, as shown in FIGS. 2C-2E. The collision avoidance scheme will be illustrated in detail below.

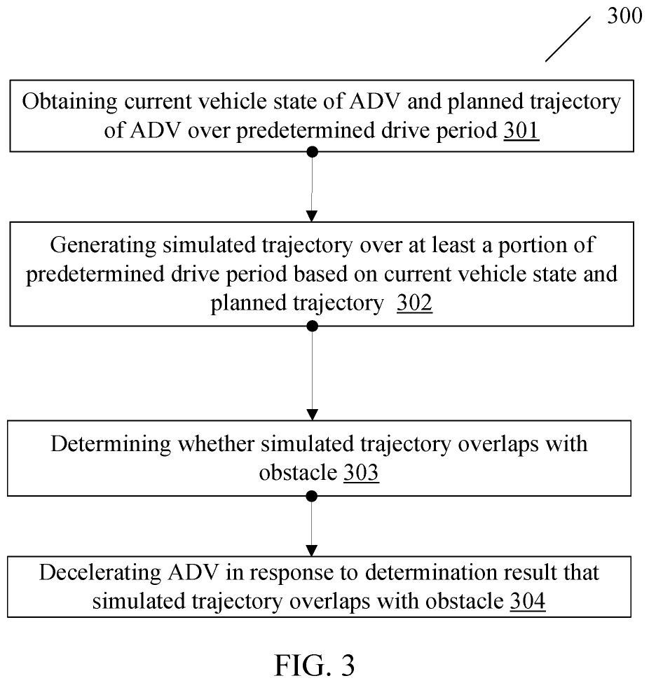

FIG. 3 illustrates a flow chart of a process 300 for collision avoidance according to one embodiment of the present disclosure. The collision avoidance process 300 may be repeatedly performed at a predetermined time interval over at least a portion of a predetermined drive period, for example, performed every 200 or 500 ms or 5 seconds. In some embodiments, the collision avoidance process 300 may be performed in response to a detection of an obstacle within a predefined range of the ADV.

Referring to FIG. 3, in step 301, a current vehicle state of the ADV and a planned trajectory of the ADV over a predetermined drive period are obtained.

Referring back to FIG. 2B, the ADV 201 deviating from the planned trajectory 202 has a current vehicle state, which in this embodiment includes a current vehicle position (x₀, y₀) and a current vehicle heading θ₀. As discussed above, the ADV 201 generates the planned trajectory 202 for a predetermined drive period based on the initial vehicle state (xᵢₙᵢ, yᵢₙᵢ; θᵢₙᵢ) of the ADV 201 and the surrounding environment of the ADV 201 when the ADV 201 is at the initial vehicle state. The planned trajectory 202 and the current vehicle state (x₀, y₀; θ₀) of the ADV 201 are obtained for subsequent processing.

According to one embodiment of the present application, after obtaining the current vehicle state of the ADV and the planned trajectory of the ADV, whether the ADV deviates from the planned trajectory is determined: in response to determining that the ADV deviates from the planned trajectory, a simulated trajectory of the ADV over at least a portion of the predetermined drive period will be generated to determine whether there is an obstacle that will collide with the ADV, as illustrated in detail below; in response to determining that the ADV does not deviate from the planned trajectory, the planned trajectory will be taken as a simulated trajectory of the ADV to determine whether there is an obstacle that will collide with the ADV, as illustrated in detail below.

According to another embodiment of the present application, after obtaining the current vehicle state of the ADV and the planned trajectory of the ADV, the deviation of the ADV from the planned trajectory is determined: if the deviation of the ADV from the planned trajectory is larger than a predefined threshold, the ADV is determined as deviating from the planned trajectory and a simulated trajectory over at least a portion of the predetermined drive period will be generated to determine whether there is an obstacle that will collide with the ADV, as illustrated in detail below; if the deviation of the ADV from the planned trajectory is not larger than a predefined threshold, the ADV is determined as not deviating from the planned trajectory and the planned trajectory will be taken as a simulated trajectory of the ADV to determine whether there is an obstacle that will collide with the ADV, as illustrated in detail below.

In step 302, a simulated trajectory over at least a portion of the predetermined drive period is generated based on the current vehicle state and the planned trajectory.

The at least a portion of the predetermined drive period may be divided into a plurality of time steps. Referring back to FIG. 2B, in this embodiment, the at least a portion of the predetermined drive period is divided into times steps 205₀, 205₁, 205₂ . . . 205₆, among which the time step 205₀ is an initial time step. The ADV 201 is currently at the initial time step 205₀ and has the current vehicle state (x₀, y₀; θ₀). To generate the simulated trajectory 204, the ADV 201 may generate a set of simulated vehicle states each corresponding to a time step 205ₖ over the at least a portion of the predetermined drive period. In some embodiments, each simulated vehicle state may include a simulated vehicle position (xₖ, yₖ) and a simulated vehicle heading θₖ. The simulated trajectory 204 may then be generated based on the set of simulated vehicle states, for example, by creating a smooth curve based on the simulated vehicle positions (xₖ, yₖ) included in each simulated vehicle state.

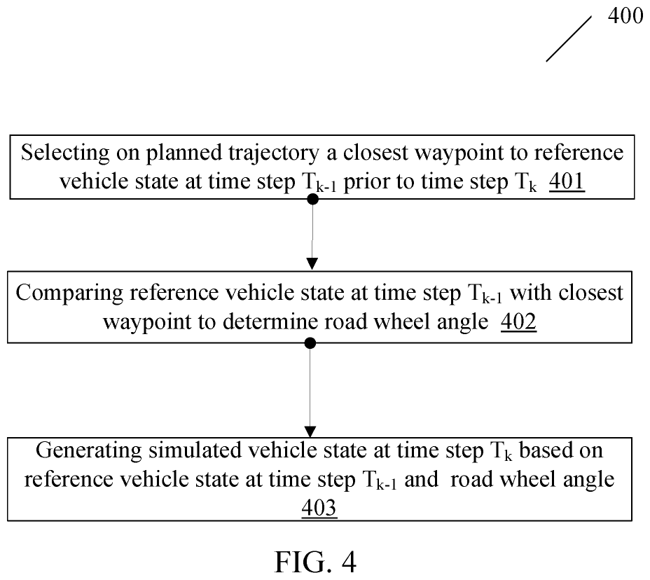

FIG. 4 illustrates a flow chart of a process 400 for generating a simulated vehicle state corresponding to a time step Tₖ over the predetermined time period according to one embodiment of the present disclosure, wherein k is a natural number. Referring back to FIG. 2B, for illustration purpose, the process for generating the simulated vehicle state of the ADV 201 corresponding to the time step 205₁ will be illustrated in detail below as an example.

In step 401, a closest waypoint to a reference vehicle state at a time step Tₖ₋₁ prior to the time step Tₖ is selected on the planned trajectory.

Referring back to FIG. 2B, to generate the simulated vehicle state of the ADV 201 corresponding to the time step 205₁, a closest waypoint to the reference vehicle state at the time step 205₀ is first selected on the planned trajectory 202. In this embodiment, the reference vehicle state at the time step 205₀ is the current vehicle state (x₀, y₀; θ₀) of the ADV 201. In this embodiment, the ADV 201 is in forward motion and the closest waypoint to the reference vehicle state of the ADV 201 is selected as the point 206 on the planned trajectory 202 that is closest to the center of the front axle 207 of the ADV 201. However, in some other embodiments that the vehicle is in reverse motion, the closest waypoint to the reference vehicle state of the vehicle can also be selected as the point on the planned trajectory that is closest to the center of the vehicle's rear axle. In other embodiments, the closest waypoint to the reference vehicle of the ADV may be selected according to other standards, for example, selecting a point on the planned trajectory that is closest to the mass center of the ADV as the closest waypoint.

In step 402, the reference vehicle state at the time step Tₖ₋₁ is compared with the closest waypoint to determine a road wheel angle.

Referring back to FIG. 2B, after selecting the point 206 as the closest waypoint to the reference vehicle state at the time step 205₀, the reference vehicle state at the time step 205₀ is compared with the point 206 to determine a road wheel angle δ(t). In this embodiment, the road wheel angle δ(t) is determined based on the following equation (1) (which is also well known in the art as Stanley Lateral Controller):

$$δ ( t ) = ( ψ ( t ) - {ψ}_{ss} ( t ) ) + arctan \frac{ke ( t )}{{k}_{soft} + v ( t )} + {k}_{d , yaw} ( {r}_{meas} - {r}_{trag} ) + {k}_{d , steer} ( {δ}_{meas} ( i ) - {δ}_{meas} ( i + 1 ) ) \qquad ( 1 )$$

where: ψ(t) is yaw angle/heading; ψₛₛ(t) is steady-state yaw; e(t) is cross-track error; v(t) is ego car speed; k, k_{soft}, k_{d,yaw}, k_{d,steer} are tuning parameters; rₘₑₐₛ, rₜᵣₐⱼ are measured yaw rate and trajectory yaw rate, respectively; δₘₑₐₛ(i), δₘₑₐₛ (i+1) are discrete-time measurements of the road wheel angle; and i is the index of measurement one control period earlier. Further, the steady-state yaw ψₛₛ(t) is defined based on the follow equation (2)

$${ψ}_{ss} = \frac{mv ( t ) {r}_{traj} ( t )}{{C}_{y} ( 1 + \frac{a}{b} )} \qquad ( 2 )$$

where: m is ego car mass; C_{y} is lateral corner stiffness; and a, b are distances from center of mass to front axle and rear axle, respectively.

Stanley Lateral Controller is detailedly illustrated in “Autonomous Automobile Trajectory Tracking for Off-Road Driving: Controller Design, Experimental Validation and Racing” (Authors: Gabriel M. Hoffmann, Claire J. Tomlin, Michael Montemerlo, Sebastian Thrun; Source Publication: American Control Conference, 2007), which is incorporated into the present disclosure by reference.

It can be understood that the road wheel angle can be calculated according to other equations in addition to the Stanley Lateral Controller and the present disclosure is not limited to a particular one.

In step 403, the simulated vehicle state at the time step Tₖ is generated based on the reference vehicle state at the time step Tₖ₋₁ and the road wheel angle.

Referring back to FIG. 2B, after determining the road wheel angle δ, the simulated vehicle state (x₁,y₁; θ₁) at the time step 205₁ can be generated based on the reference vehicle state (x₀, y₀; θ₀) at the time step 205₀, the determined road wheel angle δ, and a vehicle model. The vehicle model can be either a kinematic model or a dynamic model. The kinematic model and the dynamic model are detailedly illustrated in “Autonomous Automobile Trajectory Tracking for Off-Road Driving: Controller Design, Experimental Validation and Racing” (Authors: Gabriel M. Hoffmann, Claire J. Tomlin, Michael Montemerlo, Sebastian Thrun; Source Publication: American Control Conference, 2007), which is incorporated into the present disclosure by reference.

According to one embodiment, in a simple kinematic model, the simulated vehicle state (x₁, y₁; θ₁) at the time step 205₁ can be generated based on the following equations (3)-(6):

x₁=x₀+v₀*cos θ₀ (3)

y₁=y₀+v₀*sin θ₀*T (4)

θ₁=θ₀+ω₀*T (5)

where: v₀ is the vehicle speed at the time step 205₀; T is the sampling time between the time steps 205₀ and 205₁; ω₀ is the angular velocity at the time step 205₀ and defined based on the follow equation (6)

ω₀=v₀*tan δ₀/L (6)

where L is the wheelbase of the vehicle, or length from the front wheel center to the rear wheel center; δ₀ is the determined road wheel angle at the time step 205₀.

It can be understood that the simulated vehicle state (x₁,y₁; θ₁) at the time step 205₁ can be generated according to other equations in addition to the equations (3)-(6) illustrated above and the present disclosure is not limited to any particular equations.

It can be understood that to generate a simulated trajectory, the steps 401 to 403 of the process 400 depicted in FIG. 4 are iteratively performed until the set of simulated vehicle states corresponding to all time steps over the at least a portion of the predetermined drive period are generated. For example, referring back to FIG. 2B, the process 400 depicted in FIG. 4 is iteratively performed 6 times until the set of simulated vehicle states corresponding to time steps 205₁, 205₂, 205₃ . . . 205₆ are all generated, to generate the simulated trajectory 204.

It can be understood that the simulated vehicle state generated for the time step Tₖ can further be used as the reference vehicle state when generating a simulated vehicle state corresponding to the next time step Tₖ₊₁. For example, referring back to FIG. 2B, the simulated vehicle state generated for the time step 205₁ can be further used as a reference vehicle state when generating the simulated vehicle state corresponding to the time step 205₂. Further, it can also be understood that before iteratively performing the process 400 depicted in FIG. 4, the reference vehicle state is initialized by the current vehicle state of the ADV, i.e. the vehicle state at the initial time step T₀. That is, the current vehicle state of the ADV is used as the reference vehicle state when generating the first simulated vehicle state corresponding to the time step T₁ over the predetermined drive period. For example, referring back to FIG. 2B, before iteratively performing the process 400, the current vehicle state (x₀, y₀; θ₀) of the ADV 201 corresponding to the initial time step 205₀ is used as the reference vehicle state when generating the first simulated vehicle (x₁, y₁; θ₁) state corresponding to the time step 205₁.

Referring back to FIG. 3, in step 303, after generating the simulated trajectory over at least a portion of the predetermined drive period, whether the simulated trajectory overlaps with an obstacle is determined.

In some embodiments, during driving, the ADV scans the surrounding environment to detect existence of obstacles in the environment through, for example, cameras, radars and LiDARs mounted on the ADV. In some embodiments, the obstacle is detected based on a real-time detection manner.

Referring back to FIG. 2B, the ADV 201 scans the surrounding environment and can detect the existence of the obstacle 208. After detecting the obstacle 208, the ADV can determine that the obstacle 208 overlaps with the simulated trajectory 204.

Referring back to FIG. 3, in step 304, in response to a determination result that the simulated trajectory overlaps with an obstacle, the ADV is decelerated.

Referring back to FIG. 2B, in response to determining that the simulated trajectory 204 overlaps with the obstacle 208, which means that it is determined that the ADV 202 will collided with the obstacle 208, the ADV 202 is decelerated. Alternatively, in response to determining that no obstacle overlaps with the simulated trajectory 204, the ADV 202 will continue moving without deceleration and start over the process 300 as illustrated in detail above to avoid collision.

After the ADV is decelerated, the ADV may take different subsequent actions for different kinds of obstacles overlapping with the simulated trajectory.

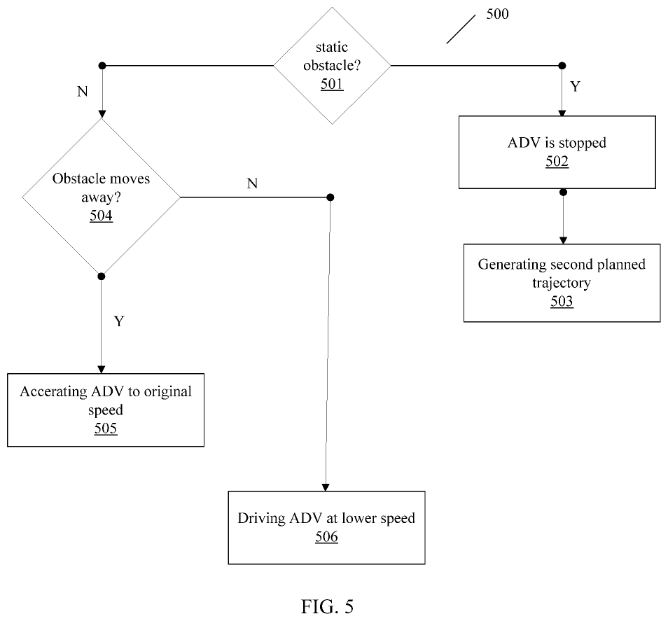

FIG. 5 illustrates a flow chart of a process 500 after decelerating the ADV according to one embodiment of the present disclosure. In Block 501, the ADV determines whether the obstacle overlapping with the simulated trajectory is a static obstacle.

In some embodiments, the ADV determines whether the obstacle overlapping with the simulated trajectory is a static obstacle based on data from the HD map module, localization module and perception module. For example, if the data from the HD map module and the localization module over a period indicates that the obstacle is a fixed object in the environment (e.g., a road barrier, a tree, a fence etc.), the obstacle is determined as a static obstacle. For another example, if the obstacle is not a fixed object on the road but the perception module does not detect the speed of the obstacle over a predefined time period, the obstacle may also be determined as a static obstacle (e.g., a parked vehicle). There are a plurality of ways to determine whether an obstacle is a static obstacle and the present disclosure is not limited to a particular one.

If the ADV determines that the obstacle overlapping with simulated trajectory is a static obstacle, the process 500 goes to Block 502; otherwise, the process 500 goes to Block 504.

In Block 502, in response to determining that the obstacle is a static obstacle, the ADV is stopped. In Block 503, after the ADV is stopped, a second planned trajectory is generated according to a second initial vehicle of the ADV and an environment of the ADV where the ADV is stopped.

If it is determined that the obstacle overlapping with the simulated trajectory is a static obstacle, it means that the obstacle will not move away from the simulated trajectory of the ADV. In that case, it is desired to stop the ADV and generate a second planned trajectory based on the second vehicle state of the ADV and the environment of the ADV where the ADV is stopped for the ADV to execute to avoid colliding with the obstacle. The second vehicle state of the ADV refers to the vehicle state of the ADV when the ADV is stopped.

Referring back to FIG. 2C, if the ADV 201 determines that the obstacle 208 overlapping with the simulated trajectory 204 is a static object, the ADV 201 is stopped. In this embodiment, the ADV 201 is stopped at a point 209. After the ADV 201 is stopped, the ADV 201 generates a second planned trajectory 210 based on the vehicle state (x_{sec}, y_{sec}; θ_{sec}) corresponding to the point 209 and the environment of the ADV 201 where the ADV 201 is stopped to avoid colliding with the obstacle 208.

In Block 504, in response to determining that the obstacle is not a static obstacle such as a human being, whether the obstacle moves away from the simulated trajectory is determined immediately or later within a short period such as 100 ms or 1 second. If it is determined that the obstacle moves away from the simulated trajectory, the process 500 goes to Block 505; otherwise, the process 500 goes to Block 506.

In Block 505, the ADV is accelerated back to the original speed; and in Block 506, the ADV is drove at a speed lower than the original speed.

In response to determining that the obstacle overlapping with the simulated trajectory is not a static obstacle, the ADV may then determine whether the obstacle moves away from the simulated trajectory. If the obstacle moves away from the simulated trajectory, it means that the obstacle no longer impedes the ADV so the ADV can be accelerated back to the original speed.

As shown in FIG. 2D, the obstacle 208 moves away from the simulated trajectory 204. In that case, the obstacle 208 no longer impedes the ADV 201 and the ADV 201 can be accelerated back to the original speed.

If the obstacle is not a static obstacle but does not move away from the simulated trajectory, i.e., still overlaps with the simulated trajectory, the ADV may be drove at a lower speed to allow more time for the non-static obstacle to move away from the simulated trajectory. However, due to safety requirements, the ADV may be stopped to plan a new trajectory if the ADV gets too close to the obstacle.

As shown in FIG. 2E, the obstacle 208 moves a certain distance but does not moves away from the simulated trajectory 204. In that case, the ADV 201 is drove at a lower speed to allow more time for the obstacle 208 to move away from the simulated trajectory 204. However, if the ADV 201 gets too close to the obstacle 208, for example, within 2 meters, due to safety requirements, the ADV 201 can be stopped to plan a new trajectory which bypasses the obstacle 208 and does not overlap with other obstacles in the environment, similar as how the previous planned trajectory is generated.

It should be noted that, the device and methods disclosed in the embodiments of the present disclosure can be implemented by other ways. The aforementioned device and method embodiments are merely illustrative. For example, flow charts and block diagrams in the figures show the architecture and the function operation according to a plurality of devices, methods and computer program products disclosed in embodiments of the present disclosure. In this regard, each frame of the flow charts or the block diagrams may represent a module, a program segment, or portion of the program code. The module, the program segment, or the portion of the program code includes one or more executable instructions for implementing predetermined logical function. It should also be noted that in some alternative embodiments, the function described in the block can also occur in a different order as described from the figures. For example, two consecutive blocks may actually be executed substantially concurrently. Sometimes they may also be performed in reverse order, depending on the functionality. It should also be noted that, each block of the block diagrams and/or flow chart block and block combinations of the block diagrams and/or flow chart can be implemented by a dedicated hardware-based systems execute the predetermined function or operation or by a combination of a dedicated hardware and computer instructions.

If the functions are implemented in the form of software modules and sold or used as a standalone product, the functions can be stored in a computer readable storage medium. Based on this understanding, the technical nature of the present disclosure, part contributing to the prior art, or part of the technical solutions may be embodied in the form of a software product. The computer software product is stored in a storage medium, including several instructions to instruct a computer device (may be a personal computer, server, or network equipment) to perform all or part of the steps of various embodiments of the present. The aforementioned storage media include: U disk, removable hard disk, read only memory (ROM), a random access memory (RAM), floppy disk or CD-ROM, which can store a variety of program codes.

Various embodiments have been described herein with reference to the accompanying drawings. It will, however, be evident that various modifications and changes may be made thereto, and additional embodiments may be implemented, without departing from the broader scope of the invention as set forth in the claims that follow.

Those skilled in the art may understand and implement other variations to the disclosed embodiments from a study of the drawings, the disclosure, and the appended claims. In the claims, the word “comprising” does not exclude other elements or steps, and the indefinite article “a” or “an” does not exclude a plurality. In applications according to present application, one element may perform functions of several technical feature recited in claims. Any reference signs in the claims should not be construed as limiting the scope. The scope and spirit of the present application is defined by the appended claims.

What is claimed is:

1. A collision avoidance method for an autonomous driving vehicle (ADV), the method comprising:
A) obtaining a current vehicle state of the ADV and a planned trajectory of the ADV over a predetermined drive period, wherein the planned trajectory is generated according to an initial vehicle state of the ADV and an environment of the ADV when the ADV is at the initial vehicle state, and wherein the initial vehicle state is a vehicle state of the ADV when the ADV is at a start point of the predetermined drive period;
B) generating a simulated trajectory over at least a portion of the predetermined drive period based on the current vehicle state and the planned trajectory;
C) determining whether the simulated trajectory overlaps with an obstacle; and
D) decelerating the ADV in response to a determination result that the simulated trajectory overlaps with an obstacle.

2. The method of claim 1, wherein the method further comprises:
determining whether the obstacle is a static obstacle; and
stopping the ADV in response to determining that the obstacle is a static obstacle.

3. The method of claim 2, wherein the method further comprises:
generating, after the ADV is stopped, a second planned trajectory according to a second initial vehicle state of the ADV and an environment of the ADV where the ADV is stopped, wherein the second initial vehicle state is a vehicle state of the ADV when the ADV is stopped.

4. The method of claim 2, wherein the method further comprises:
determining whether the obstacle moves away from the simulated trajectory;
accelerating the ADV to a speed when the ADV is at the current vehicle state, in response to determining that the obstacle is not a static obstacle and moves away from the simulated trajectory; and
driving the ADV at a speed lower than the speed when the ADV is at the current vehicle state, in response to determining that the obstacle is not a static obstacle but does not move away from the simulated trajectory.

5. The method of claim 1, wherein the steps A to D are repeated at a predetermined time interval over at least a portion of the predetermined drive period.

6. The method of claim 1, wherein the step B comprises:
generating a set of simulated vehicle states each corresponding to a time step over the predetermined drive period; and
generating the simulated trajectory based on the set of simulated vehicle states.

7. The method of claim 6, wherein generating a simulated vehicle state of the set of simulated vehicle states at a time step Tₖ (k is a natural number) over the predetermined period comprises:
selecting on the planned trajectory a closest waypoint to a reference vehicle state at a time step Tₖ₋₁ prior to the time step Tₖ;
comparing the reference vehicle state with the closest waypoint to determine a road wheel angle; and
generating the simulated vehicle state at the time step Tₖ based on the reference vehicle state and the road wheel angle;
wherein the reference vehicle state is initialized by the current vehicle state at an initial time step T₀.

8. The method of claim 1, wherein the current vehicle state comprises a current vehicle position and a current vehicle heading.

9. The method of claim 1, wherein each of the set of simulated vehicle states comprises a simulated vehicle position and a simulated vehicle heading.

10. The method of claim 1, further comprising:
scanning the environment of the ADV to detect existence of obstacles in the environment.

11. The method of claim 10, wherein the obstacle is detected based on a real-time detection manner.

12. A device for controlling an autonomous driving vehicle (ADV), the device comprising:
a processor; and
a memory for storing instructions executable by the processor;
wherein the processor is configured to perform a collision avoidance method for controlling the ADV, wherein the method comprises:
A) obtaining a current vehicle state of the ADV and a planned trajectory of the ADV over a predetermined drive period, wherein the planned trajectory is generated according to an initial vehicle state of the ADV and an environment of the ADV when the ADV is at the initial vehicle state, and wherein the initial vehicle state is a vehicle state of the ADV when the ADV is at a start point of the predetermined drive period;
B) generating a simulated trajectory over at least a portion of the predetermined drive period based on the current vehicle state and the planned trajectory;
C) determining whether the simulated trajectory overlaps with an obstacle; and
D) decelerating the ADV in response to a determination result that the simulated trajectory overlaps with an obstacle.

13. A non-transitory computer-readable storage medium having stored therein instructions that, when executed by a processor, causes the processor to perform a collision avoidance method for controlling an autonomous driving vehicle (ADV), wherein the method comprises:
A) obtaining a current vehicle state of the ADV and a planned trajectory of the ADV over a predetermined drive period, wherein the planned trajectory is generated according to an initial vehicle state of the ADV and an environment of the ADV when the ADV is at the initial vehicle state, and wherein the initial vehicle state is a vehicle state of the ADV when the ADV is at a start point of the predetermined drive period;
B) generating a simulated trajectory over at least a portion of the predetermined drive period based on the current vehicle state and the planned trajectory;
C) determining whether the simulated trajectory overlaps with an obstacle; and
D) decelerating the ADV in response to a determination result that the simulated trajectory overlaps with an obstacle.
